(19) United States
(12) Patent Application Publication
(10) Pub. No.: US 2015/0046664 A1
(43) Pub. Date: Feb. 12, 2015

(54) Storage Control System with Settings Adjustment Mechanism and Method of Operation Thereof

(71) Applicant: Smart Storage Systems, Inc., Milpitas, CA (US)

(72) Inventors: James Fitzpatrick, Sudbury, MA (US); Sheunghee Park, Pleasanton, CA (US); Bernardo Rub, Sudbury, MA (US); James M. Higgins, Chandler, AZ (US)

(21) Appl. No.: 14/446,249

(22) Filed: Jul. 29, 2014

Related U.S. Application Data
(60) Provisional application No. 61/863,794, filed on Aug. 8, 2013.

(51) Int. Cl. G06F 3/06

(52) U.S. Cl. CPC G06F 3/0616; G06F 3/0634; G06F 3/0679
USPC 711/156

(57) ABSTRACT

Systems, methods and/or devices are used to enable a settings adjustment mechanism. In one aspect, the method includes (1) accessing characterization information corresponding to how a group of non-volatile memory devices of a storage control system operates as the group wears, (2) determining an estimated age of a non-volatile memory device, of the group of non-volatile memory devices, in accordance with a wear indicator for the non-volatile memory device, and (3) determining one or more settings for the non-volatile memory device in accordance with the estimated age and the characterization information.

### RELATED APPLICATION

This application claims priority to U.S. Provisional Patent Application Ser. No. 61/863,794, filed Aug. 8, 2013, entitled “Storage Control System with Settings Adjustment Mechanism and Method of Operation Thereof,” which is hereby incorporated by reference in its entirety.

### TECHNICAL FIELD

The present invention relates generally to a storage control system and more particularly to a system for data management.

### BACKGROUND

Data storage, often called storage or memory, refers to computer components and recording media that retain digital data. Data storage is a core function and fundamental component of consumer and industrial electronics, especially devices such as computers, televisions, cellular phones, mobile devices, and digital video cameras.

Recently, forms of long-term storage other than electromechanical hard disks have become feasible for use in computers. NOT-AND (NAND) flash is one form of non-volatile memory used in solid-state storage devices. The memory cells are arranged in typical row and column fashion with circuitry for accessing individual cells. The memory transistors of those cells are placed to store an analog value that can be interpreted to hold two logical states in the case of Single Level Cell (SLC) or more than two logical states in the case of Multi Level Cell (MLC). In the industry, MLC typically refers to four levels within a cell (i.e., stores 2 bits/cell). MLC can also include 3 bits per cell, which is typically referred to as Triple Level Cell (TLC).

A flash memory cell is light in weight, occupies very little space, and consumes less power than electromechanical disk drives. Construction of a storage system with this type of memory allows for much higher bandwidths and input/output operations per second (IOPS) than typical electromechanical disk drives. More importantly, it is especially rugged and can operate across a wider temperature range. It will withstand without adverse effects repeated drops, each of which would destroy a typical electromechanical hard disk drive. A problem exhibited by flash memory is that it tends to have a limited life in use.

Thus, a need still remains for better data management devices. In view of the increasing demand for data management devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### BRIEF DESCRIPTION OF THE DRAWINGS

FIG. 1 is a storage control system with settings adjustment mechanism in an embodiment of the present invention.

FIG. 2 is an exemplary hardware block diagram of the main memory controller.

FIG. 3 is a flow diagram of the settings adjustment mechanism.

FIG. 4 is an exemplary implementation of the settings translator module.

FIG. 5 is a flow chart of a method of operation of a storage control system in a further embodiment of the present invention.

### DETAILED DESCRIPTION

The various implementations described herein include systems, methods and/or devices used to enable a settings adjustment mechanism. Some implementations include systems, methods and/or devices to determine one or more settings for a non-volatile memory device in accordance with an estimated age of the non-volatile memory device and characterization information.

More specifically, some embodiments include a method of operation of a storage control system. In some embodiments, the method includes (1) accessing characterization information corresponding to how a group of non-volatile memory devices of the storage control system operates as the group wears, (2) determining an estimated age of a non-volatile memory device, of the group of non-volatile memory devices, in accordance with a wear indicator for the non-volatile memory device, and (3) determining one or more settings for the non-volatile memory device in accordance with the estimated age and the characterization information.

In some embodiments, the method further includes using the determined one or more settings for the non-volatile memory device to adjust operating characteristics of the non-volatile memory device.

In some embodiments, the characterization information identifies different settings to use for different ages of a respective non-volatile memory device of the group of non-volatile memory devices.

In some embodiments, the estimated age represents the estimated wear on the non-volatile memory device.

In some embodiments, the one or more settings for the non-volatile memory device are determined in accordance with the estimated age and the characterization information to promote even performance as the non-volatile memory device ages.

In some embodiments, the one or more settings for the non-volatile memory device are determined in accordance with the estimated age and the characterization information to promote even power usage as the non-volatile memory device ages.

In some embodiments, the one or more settings for the non-volatile memory device are determined in accordance with the estimated age and the characterization information to maximize endurance of the non-volatile memory device.

In some embodiments, determining the estimated age of the non-volatile memory device includes filtering that limits impact of outlier measurements on the estimated age.

In another aspect, any of the methods described above are performed by a storage control system, the storage control system including (1) one or more processors, and (2) memory storing one or more programs to be executed by the one or more processors, the one or more programs comprising instructions for performing or controlling performance of any of the methods described herein.

In yet another aspect, some embodiments include a non-transitory computer readable storage medium, storing one or more programs configured for execution by one or more processors of a storage control system, the one or more programs including instructions for performing or controlling performance of any of the methods described herein.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGS.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a microelectromechanical system (MEMS), passive devices, environmental sensors including temperature sensors, or a combination thereof.

The term “erase block” referred to herein is defined as a group of pages, which is the smallest number of pages that are erased at one time. The term “page” referred to herein is defined as a memory component within an erase block that is programmed as an individual unit. The page is a smallest group of data bytes that are read from or written to in an erase block. Technically, a portion of a page can be read at a time.

The term “endurance” referred to herein is defined as a number of program and erase operations a memory device including NAND flash device tolerates over a given period of operational life of a storage system including a solid state disk drive (SSD). Read operations are effectively without damage. Endurance is an ability of a drive or an SSD to withstand program/erase (P/E) cycles. For example, endurance is typically measured in terms of Drive Writes per Day (DWPD) over a timeframe or in terms of host Terabytes Written (TBW).

The term “program/erase cycle” (P/E cycle) referred to herein is defined as a base level operation of how data is replaced within an erase block. For example, a memory device including NAND and other memory types can have a limited number of useful P/E cycles.

The term “age” referred to herein is defined as a measure of an ability of non-volatile memories including NANDs to reliably store data. Young-aged non-volatile memories have better data retention capability. Older-aged non-volatile memories have worse data retention capability and higher error rates (even without retention).

An age is an estimate of the wear on a non-volatile memory. There are numerous methods for measuring an age of a non-volatile memory. For example, these methods include at least P/E cycle counts, bit error rate (BER), program time, optimal read threshold, and erase time.

As a non-volatile memory including flash wears, the quality of programming and erasing degrades. At old ages, every program command results in a page written with errors therein. At the beginning of life, there are seldom errors in any individual programmed page. With the high error rates at the end of life, there is less margin for tolerating signal degradation from retention.

The term “retention” referred to herein is defined as an ability of memory cells to retain the programmed or correct information. Retention refers to an amount of correct data after a given period, which is a time when a drive is powered, not powered, or a combination thereof.

The term “bit error rate” (BER) referred to herein is defined as a number of incorrect bits in a data stream stored in a memory device including NAND. The BER is detected within a code word protected by error correction code (ECC).

The term “code word” referred to herein is defined as a group of data bytes covered by a single of multiple error correction code (ECC) parity words. The term “error correction code” (ECC) referred to herein is defined as parity data generated over a set of data grouped into a code word. ECC allows a limited or predefined number of data bits in error in a data stream to be detected and corrected.

The term “host performance” referred to herein is defined as how much work a host system achieves interfacing to an SSD. Key measurements of the host performance include throughput, average latency, worst-case latency, and latency deviation. The key measurements can be applied to any combinations of host write and host read distributions, sizes, and queue depths.

The term “wear” referred to herein is defined as an erosion of a non-volatile memory cell due to use, including program/erase cycles on a non-volatile memory including NAND flash. The term “wear indicators” referred to herein is defined as measurements and predictive models that help estimate the wear on a non-volatile memory.

Embodiments of the present invention described herein solve a number of problems. As a non-volatile memory wears, its behavior changes substantially or significantly. In particular, as the non-volatile memory ages, it becomes harder to retain data reliably, its program times decrease, and its erase times increase. As the non-volatile memory including flash wears, the quality of program commands degrades and the error rate increases.

This presents two important problems for an SSD. A host performance of a drive or the SSD can be uneven as the drive ages. The drive can also have difficulty retrieving data as the drive ages. As the drive wears down, the host performance can degrade because there are more complicated algorithms to interpret the data. As the drive wears down, the host performance can also speed up because it becomes easier to write the non-volatile memory from a firmware perspective.

Although the embodiments described herein refer to ‘flash’ and ‘flash settings’, it is understood that the principle or the embodiments can be applied to any non-volatile memory that wears out with use. Typically, the SSD does not tune the non-volatile memory including flash to try to overcome these issues. As a result, typical SSDs (especially those using MLC flash) have variability in performance across their lifespans and have lifespans shorter than those that are theoretically possible. The lifespan of an SSD can be often dictated by the weakest die in the drive and is thus often shorter than the typical lifespan of an average die.

This invention attacks or resolves both of these issues by adjusting settings or configurations of the non-volatile memory as the non-volatile memory ages. Up to this point, there has been no mention of the fact that a non-volatile memory device including NAND is programmed with parameters that do not change over the life of the non-volatile memory device. Adjusting the parameters that control a programming operation, an erasing operation, a reading operation, or other voltages within the non-volatile memory device including flash during operation is currently an extremely rare situation. The SSD uses a method of estimating the wear, and based on characterizations of the non-volatile memory's behavior, the SSD applies the settings that even out performance across the drive's life and extend the drive's endurance.

An ability of the embodiments described herein to extend the endurance of the drive to support more host writes is one of key competitive advantages in the market. Maintaining even performance throughout the drive's life is also a key claim.

As the non-volatile memory including flash wears, it becomes harder to erase and easier to program. As a result, if parameters of the non-volatile memory are not dynamically adjusted, program times become shorter (i.e. faster) and erase times become longer (i.e. slower). Overall, the program times dominate and the drives tend to have faster write performance as aging continues. Read performance is impacted by increased need or read retries as the non-volatile memory wears. Adjusting read parameters throughout the life of the non-volatile memory can help maintain constant read performance throughout the life of the non-volatile memory.

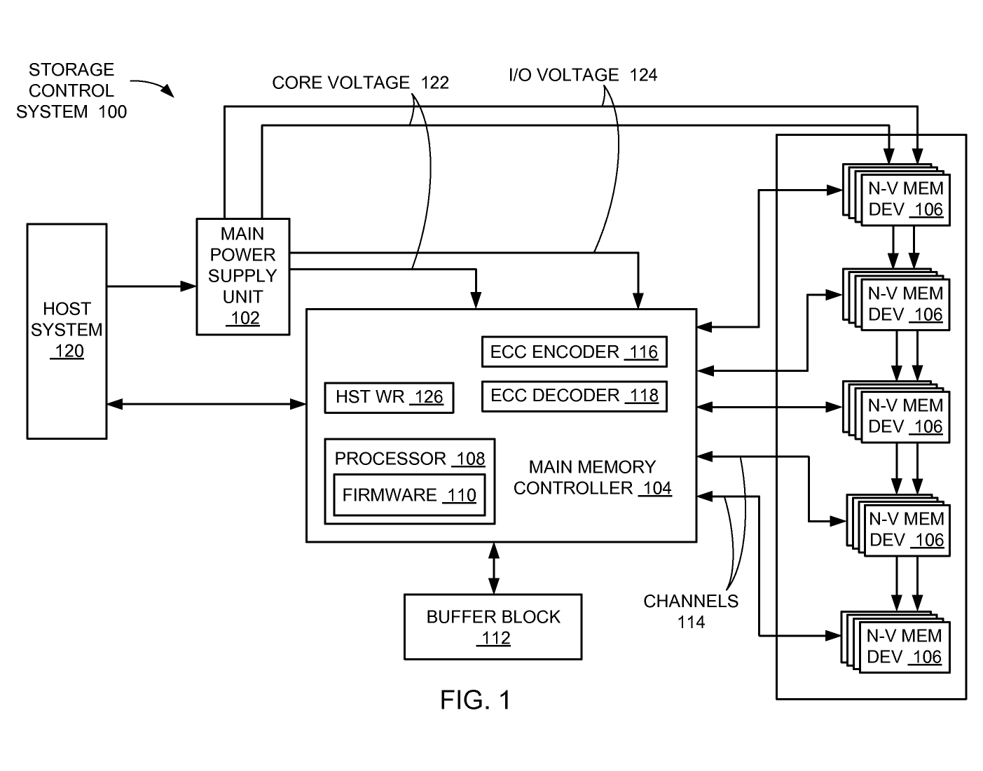

Referring now to FIG. 1, therein is shown a storage control system 100 with settings adjustment mechanism in an embodiment of the present invention. FIG. 1 depicts a system level block diagram of the storage control system 100. The storage control system 100 can include a method of adjusting settings or configurations of a non-volatile memory including a flash device as the non-volatile memory ages.

This figure can represent a hardware architecture of a solid state drive (SSD). The concept described herein can be constructed and used in a solid state drive. This concept can also be retrofitted into almost any SSD product to improve the amount of writes that the SSD can handle.

The storage control system 100 includes drive level components. The drive level components includes a section for a main power supply unit 102 for providing power supplies to a main memory controller 104 and non-volatile memory devices 106. The main memory controller 104 including a NAND controller includes a processor 108, device controllers (not shown), and memory controllers (not shown). The processor 108 including a central processing unit (CPU) is used to execute a firmware 110.

The device controllers interface with and control the non-volatile memory devices 106 including NAND flash. The interface can be used to issue read, program, or erase commands. The interface can also be used to reconfigure the parameters and voltages used for programming, erasing, and reading.

Although the embodiments described herein refer to using NAND for the non-volatile memory devices 106, it is understood that the embodiments are not limited to using NAND as a memory storage device, which can be monitored and controlled by the main memory controller 104. For example, the non-volatile memory devices 106 include but are not limited to Magnetoresistive random-access memory (MRAM), Ferroelectric RAM (FRAM), and phase-change memory (PCM).

The memory controllers control and interface with a buffer block 112, which is a memory device. For example, in some cases, the buffer block 112 is an external block of memory for tabling and storing data or an array of NAND memory devices. Also for example, the buffer block 112 includes memory and data buffers. Further, for example, the buffer block 112 can include dynamic random access memory (DRAM) or any other volatile memories.

The storage control system 100 includes a number of channels 114 with each of the channels 114 having a number of the non-volatile memory devices 106 including NAND flash devices behind it. There are a number of ways of distributing the data across the channels 114. For example, the data can be distributed using a simple redundant array of independent disks (RAID) 0 stripe. For example, FIG. 1 shows five of the channels 114, although it is understood that there can be any number of the channels 114.

The main memory controller 104 includes an ECC encoder 116 and an ECC decoder 118. The ECC encoder 116 generates ECC parity data for a set of data grouped into a code word to be stored in the non-volatile memory devices 106. The ECC decoder 118 receives and checks ECC parity data for data from the non-volatile memory devices 106. The main memory controller 104 interfaces with a host system 120.

In this configuration, there is no power feedback from any of the components. The main power supply unit 102 is a self-contained unit that generates and provides power for all of the components of the drive based on or sourced by a main host power input from the host system 120. The main power supply unit 102 provides a core voltage 122 and an input/output voltage 124 to the main memory controller 104 and the non-volatile memory devices 106.

For illustration purposes, only the powers from the main power supply unit 102 are shown, although it is understood that there can be other power signals in the storage control system 100. For example, the storage control system 100 can include power feedback signals from any of the components and most importantly a bank of the non-volatile memory devices 106 including NAND memory devices.

The host system 120 can send requests and data to the main memory controller 104 to perform host writes 126. The host writes 126 are defined as operations performed by the main memory controller 104 for storing the data from the host system 120 to the non-volatile memory devices 106. The interface to the non-volatile memory devices 106 can be used to reconfigure internal parameters of the non-volatile memory devices 106.

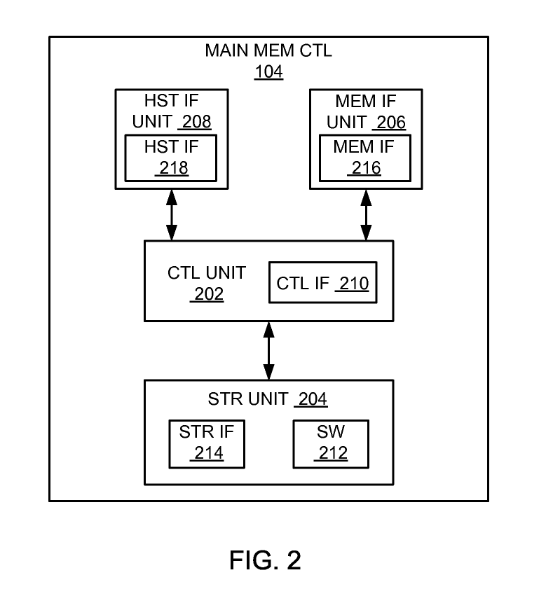

Referring now to FIG. 2, therein is shown an exemplary hardware block diagram of the main memory controller 104. The main memory controller 104 can include a control unit 202, a storage unit 204, a memory interface unit 206, and a host interface unit 208. The control unit 202 can include a control interface 210. The control unit 202 can execute a software 212 stored in the storage unit 204 to provide the intelligence of the main memory controller 104.

The control unit 202 can be implemented in a number of different manners. For example, the control unit 202 can be a processor, an embedded processor, a microprocessor, a hardware control logic, a hardware finite state machine (FSM), a digital signal processor (DSP), or a combination thereof.

The control interface 210 can be used for communication between the control unit 202 and other functional units in the main memory controller 104. The control interface 210 can also be used for communication that is external to the main memory controller 104.

The control interface 210 can receive information from the other functional units or from external sources, or can transmit information to the other functional units or to external destinations. The external sources and the external destinations refer to sources and destinations external to the main memory controller 104.

The control interface 210 can be implemented in different ways and can include different implementations depending on which functional units or external units are being interfaced with the control interface 210. For example, the control interface 210 can be implemented with a dedicated hardware including an application-specific integrated circuit (ASIC), a configurable hardware including a field-programmable gate array (FPGA), a discrete electronic hardware, or a combination thereof.

The storage unit 204 can include both hardware and the software 212. For example, the software 212 can include control firmware. The storage unit 204 can include a volatile memory, a nonvolatile memory, an internal memory, an external memory, or a combination thereof. For example, the storage unit 204 can be a nonvolatile storage such as non-volatile random access memory (NVRAM), Flash memory, disk storage, or a volatile storage such as static random access memory (SRAM).

The storage unit 204 can include a storage interface 214. The storage interface 214 can also be used for communication that is external to the main memory controller 104. The storage interface 214 can receive information from the other functional units or from external sources, or can transmit information to the other functional units or to external destinations. The external sources and the external destinations refer to sources and destinations external to the main memory controller 104.

The storage interface 214 can include different implementations depending on which functional units or external units are being interfaced with the storage unit 204. The storage interface 214 can be implemented with technologies and techniques similar to the implementation of the control interface 210.

The memory interface unit 206 can enable external communication to and from the main memory controller 104. For example, the memory interface unit 206 can permit the main memory controller 104 to communicate with the non-volatile memory devices 106 of FIG. 1.

The memory interface unit 206 can include a memory interface 216. The memory interface 216 can be used for communication between the memory interface unit 206 and other functional units in the main memory controller 104. The memory interface 216 can receive information from the other functional units or can transmit information to the other functional units.

The memory interface 216 can include different implementations depending on which functional units are being interfaced with the memory interface unit 206. The memory interface 216 can be implemented with technologies and techniques similar to the implementation of the control interface 210.

The host interface unit 208 allows the host system 120 of FIG. 1 to interface and interact with the main memory controller 104. The host interface unit 208 can include a host interface 218 to provide communication mechanism between the host interface unit 208 and the host system 120.

The control unit 202 can operate the host interface unit 208 to send control or status information generated by the main memory controller 104 to the host system 120. The control unit 202 can also execute the software 212 for the other functions of the main memory controller 104. The control unit 202 can further execute the software 212 for interaction with the non-volatile memory devices 106 via the memory interface unit 206.

The functional units in the main memory controller 104 can work individually and independently of the other functional units. For illustrative purposes, the main memory controller 104 is described by operation of the main memory controller 104 with the host system 120 and the non-volatile memory devices 106. It is understood that the main memory controller 104, the host system 120, and the non-volatile memory devices 106 can operate any of the modules and functions of the main memory controller 104.

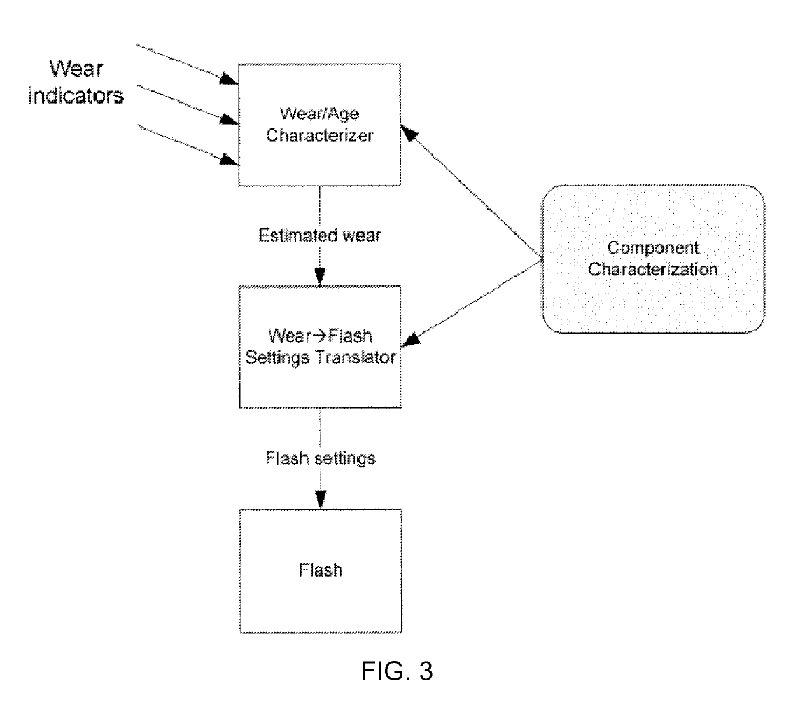

Referring now to FIG. 3, therein is shown a flow diagram of the settings adjustment mechanism. FIG. 3 depicts a high-level view of the settings adjustment mechanism in the main memory controller 104 of FIG. 1. Although the details of the settings applied to the non-volatile memory devices 106 of FIG. 1 are not discussed in the embodiments, it is understood that any operation performed that affects the behavior and timing of operations of the non-volatile memory devices 106 are referred to generically as the settings including “flash settings”.

Key components of this invention include (a) a component characterization device, (b) an age characterizer module such as wear characterizer, and (c) a settings translator module. The component characterization device determines how a given population of memory components will behave as the components wear. The age characterizer module estimates the wear on a particular non-volatile memory device including flash during the drive's life. The settings translator module uses the wear estimation to apply settings to the non-volatile memory device during the drive's life.

The component characterization device generates characteristic information for a group of non-volatile memory components. The component characterization device can typically include a machine, a process, or a combination thereof for an engineer who studies the non-volatile memory devices including flash and develops a model of how to best configure the non-volatile memory devices at each age in life.

The age characterizer module determines an estimated age of one of the non-volatile memory devices 106 based on the wear indicators and/or the characteristic information. The settings translator module converts the estimated age to predetermined settings that should be used for the estimated age. The settings translator module configures the non-volatile memory devices based on the predetermined settings.

The component-characterization step influences the drive operation by indicating how the population of flash will operate as it wears, and identifies the best flash settings to use for the different ages. This characterization can be done over a large or small population of flash depending on need and expected manufacturing process variations among sub-populations including batches or lots of semiconductor wafers. For example, the component-characterization step can be performed for different generations of the non-volatile memory components with different process geometries.

Sometimes, the settings for the non-volatile memory devices including flash can be suboptimal for typical non-volatile memory devices but very helpful for the weakest or outlier pieces or non-volatile memory devices. This ensures that even the weakest non-volatile memory device behaves sufficiently well.

The component characterization device reports the characteristic information before the design and manufacture of the drive. This process occurs during the manufacture of the non-volatile memory components to create the predetermined settings. The characteristic information is used to indicate how the group of the non-volatile memory components operate as they wear.

An input to the age characterizer module from the component characterization device includes information associated with the learning and knowledge gained from a component characterization process. For example, the component characterization process includes a method of wearing down the non-volatile memory components using repeated programming and erasing operations.

The component characterization process then determines if there are good indicators of the amount of wear on the non-volatile memory components. For example, the indicators can include BER, program time, erase time, or any indirect indicators.

The wear characterizer takes various possible indications of wear into account when estimating the wear on the component it is characterizing. For example, the wear characterizer may use the BER observed when reading pages from the flash component. It may also characterize the wear based on a sampling of the BER observed when reading pages from the flash component; other wear indicators are also possible.

The wear characterizer instantaneously takes snapshots of the age of each of the non-volatile memory devices 106. The wear characterizer includes a filtering process that excludes some of the individual measurements that are noisier and not aligned with other measurements.

The wear characterizer may employ an age filter used for the filtering process that forces the ages to move a certain way. Possible aspects of the age filter include a slew rate limiter that prevents the age from responding too quickly to outlier measurements. The possible aspects also include hysteresis to prevent the age from straying too far from recent past measurements and a restriction that the age move monotonically to prevent outlier measurements from making the flash look younger.

The outlier measurements are filtered out using the filtering process, which can include a liner or non-linear filtering method. The outlier measurements provide numerical values that are outside a predetermined range of numerical values. For example, the outlier measurements may be associated with a BER value that is less than or greater than a predetermined threshold below or above, respectively, an average of BER values measured.

A settings translator module including a flash settings translator converts the estimated wear into the predetermined settings to apply to the non-volatile memory devices 106. This conversion is not restricted to any particular solution. The conversion is performed based on the predetermined settings generated by the component characterization device for different ages. The settings translator module configures the non-volatile memory devices by setting parameters in the non-volatile memory devices 106 using the predetermined settings that are learned or generated from the component characterization process.

Functions or operations of the main memory controller 104 as described above can be implemented using modules using hardware, software, or a combination thereof. The main memory controller 104 can be implemented with the control unit 202 of FIG. 2, the storage unit 204 of FIG. 2, the memory interface unit 206 of FIG. 2, the host interface unit 208 of FIG. 2, or a combination thereof.

The storage control system 100 is described with module functions or order as an example. The modules can be partitioned differently. Each of the modules can operate individually and independently of the other modules.

Furthermore, data generated in one module can be used by another module without being directly coupled to each other. Yet further, the modules can be implemented as hardware accelerators (not shown) within the control unit 202 or can be implemented as hardware accelerators (not shown) in the main memory controller 104 or outside of the main memory controller 104.

The physical transformation of configuring the non-volatile memory devices 106 based on the predetermined settings and the estimated age results in movement in the physical world, such as people using the main memory controller 104 based on the operation of the storage control system 100. As the movement in the physical world occurs, the movement itself creates additional information that is converted back to determining the estimated age of one of the non-volatile memory devices 106 based on the wear indicators and/or the characteristic information for the continued operation of the storage control system 100 and to continue the movement in the physical world.

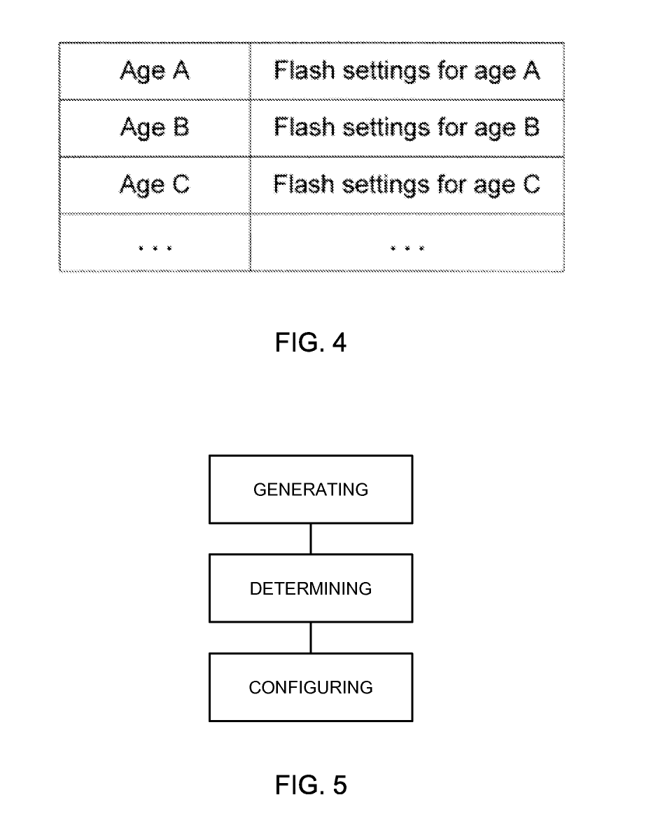

Referring now to FIG. 4, therein is shown an exemplary implementation of the settings translator module. FIG. 4 shows an example of the settings translator module that uses a lookup table to convert between the estimated age and the predetermined settings that should be used for the estimated age.

Note that in this method, a memory component may be any subset of memory including the non-volatile memory devices 106 used on the SSD. For example, the wear characterizer can characterize wear at a die level. Also for example, the wear characterizer can do so at an erase block level or even a page level.

The settings translator module may use the predetermined settings including flash settings to even out the execution time of program and/or erase operations for different flash ages. More broadly, it may use the flash settings to even out the total host performance for different flash ages.

Flash at different ages can handle different flash settings while retaining data reliably. Thus, the settings translator module may use the flash settings to maximize the drive's endurance. Of course, in practice it will use both of these important goals when deciding which of the flash settings to use. The flash settings that the settings translator module uses are a product of extensive characterization that uncovers flash behavior at different ages and with different flash settings.

Aspects of the invention include:
1. A method for using run-time trends and measurements to adjust the operating characteristics of a group of memory devices in a storage device (SSD). The operating characteristics are operational capabilities of the non-volatile memory devices. The operating characteristics can include information used to identify the non-volatile memory devices or portions of the non-volatile memory devices. The operating characteristics can include information associated with current states of erase blocks in the non-volatile memory devices or how the erase blocks are currently used.
2. A priori knowledge via device characterization and run-time measurements is used to guide the adjustments of “flash settings” to enhance the drive life.
3. A priori knowledge via device characterization and run time measurements to guide the adjustments of flash settings to allow the storage device (SSD) to have consistent I/O performance and bandwidth operations.
4. The SSD has a method of translating an estimated wear (i.e., age) into flash settings that are optimized for the level of estimated wear.
5. There is a component-characterization step that results in a model for how the flash ages and how to tune it based on some observed level of wear in order to maximize the drive's life. This step is based on a collection of data on a population, not the individual flash component.
6. The SSD may tune flash settings to promote even host performance over the drive's life.
7. The SSD has a method of collecting wear indicators for flash components and translating them into an age that represents the estimated wear on the flash component.
8. The SSD may tune flash settings to promote even power usage over the drive's life.
9. The SSD may tune flash settings to maximize the drive's endurance.

Referring now to FIG. 5, therein is shown a flow chart of a method of operation of a storage control system in a further embodiment of the present invention. The method includes: generating characteristic information for a group of non-volatile memory components; determining an estimated age of a non-volatile memory device based on a wear indicator and/or the characteristic information; and configuring the non-volatile memory device based on a predetermined setting and the estimated age.

Accordingly, it has been discovered that the values of the embodiments described above provide advantages that will go a long way to improving overall capabilities of a product line and reducing the cost of the product line in general. The advantages include improved performance, improved reliability, and improved data integrity of the storage control system.

Thus, it has been discovered that the storage control system of the present invention furnishes important and heretofore unknown and unavailable solutions, capabilities, and functional aspects for a storage control system with settings adjustment mechanism. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

It will be understood that, although the terms “first,” “second,” etc. may be used herein to describe various elements, these elements should not be limited by these terms. These terms are only used to distinguish one element from another. For example, a first setting could be termed a second setting, and, similarly, a second setting could be termed a first setting, without changing the meaning of the description, so long as all occurrences of the “first setting” are renamed consistently and all occurrences of the “second setting” are renamed consistently. The first setting and the second setting are both settings, but they are not the same setting.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of operation of a storage control system comprising:
accessing characterization information corresponding to how a group of non-volatile memory devices of the storage control system operates as the group wears;
determining an estimated age of a non-volatile memory device, of the group of non-volatile memory devices, in accordance with a wear indicator for the non-volatile memory device; and
determining one or more settings for the non-volatile memory device in accordance with the estimated age and the characterization information.

2. The method of claim 1, further comprising:
using the determined one or more settings for the non-volatile memory device to adjust operating characteristics of the non-volatile memory device.

3. The method of claim 1, wherein the characterization information identifies different settings to use for different ages of a respective non-volatile memory device of the group of non-volatile memory devices.

4. The method of claim 1, wherein the estimated age represents the estimated wear on the non-volatile memory device.

5. The method of claim 1, wherein the one or more settings for the non-volatile memory device are determined in accordance with the estimated age and the characterization information to promote even performance as the non-volatile memory device ages.

6. The method of claim 1, wherein the one or more settings for the non-volatile memory device are determined in accordance with the estimated age and the characterization information to promote even power usage as the non-volatile memory device ages.

7. The method of claim 1, wherein the one or more settings for the non-volatile memory device are determined in accordance with the estimated age and the characterization information to maximize endurance of the non-volatile memory device.

8. The method of claim 1, wherein determining the estimated age of the non-volatile memory device includes filtering that limits impact of outlier measurements on the estimated age.

9. A storage control system, comprising:
one or more processors; and
memory storing one or more programs to be executed by the one or more processors, the one or more programs comprising instructions for:
accessing characterization information corresponding to how a group of non-volatile memory devices of the storage control system operates as the group wears;
determining an estimated age of a non-volatile memory device, of the group of non-volatile memory devices, in accordance with a wear indicator for the non-volatile memory device; and
determining one or more settings for the non-volatile memory device in accordance with the estimated age and the characterization information.

10. The storage control system of claim 9, wherein the one or more programs further comprise instructions for:
using the determined one or more settings for the non-volatile memory device to adjust operating characteristics of the non-volatile memory device.

11. The storage control system of claim 9, wherein the characterization information identifies different settings to use for different ages of a respective non-volatile memory device of the group of non-volatile memory devices.

12. The storage control system of claim 9, wherein the estimated age represents the estimated wear on the non-volatile memory device.

13. The storage control system of claim 9, wherein determining the estimated age of the non-volatile memory device includes filtering that limits impact of outlier measurements on the estimated age.

14. A non-transitory computer readable storage medium, storing one or more programs configured for execution by one or more processors of a storage control system, the one or more programs including instructions for:
accessing characterization information corresponding to how a group of non-volatile memory devices of the storage control system operates as the group wears;
determining an estimated age of a non-volatile memory device, of the group of non-volatile memory devices, in accordance with a wear indicator for the non-volatile memory device; and
determining one or more settings for the non-volatile memory device in accordance with the estimated age and the characterization information.

15. The non-transitory computer readable storage medium of claim 14, wherein the one or more programs further include instructions for:
using the determined one or more settings for the non-volatile memory device to adjust operating characteristics of the non-volatile memory device.

16. The non-transitory computer readable storage medium of claim 14, wherein the characterization information identifies different settings to use for different ages of a respective non-volatile memory device of the group of non-volatile memory devices.

17. The non-transitory computer readable storage medium of claim 14, wherein the estimated age represents the estimated wear on the non-volatile memory device.

18. The non-transitory computer readable storage medium of claim 14, wherein determining the estimated age of the non-volatile memory device includes filtering that limits impact of outlier measurements on the estimated age.
